(19) United States
(12) Patent Application Publication
(10) Pub. No.: US 2019/0210421 A1
(43) Pub. Date: Jul. 11, 2019

(54) SYSTEM AND METHOD FOR REDUCING ENERGY CONSUMPTION BY AN ACTIVE SUSPENSION SYSTEM

(71) Applicant: Honda Motor Co., Ltd., Tokyo (JP)

(72) Inventors: Brandon E. RICKETTS, Marysville, OH (US); Dirk G. WESTENDORF, Marysville, OH (US); Jason A. SOVERN, Marysville, OH (US); Seth A. RITCHIE, Marysville, OH (US); Takumi MAKABE, Dublin, OH (US)

(21) Appl. No.: 16/354,523

(22) Filed: Mar. 15, 2019

Related U.S. Application Data
(63) Continuation-in-part of application No. 15/679,895, filed on Aug. 17, 2017.

(51) Int. Cl. B60G 17/018; B60G 17/016

(52) U.S. Cl. CPC B60G 17/018; B60G 17/017; B60G 17/0164

(57) ABSTRACT

A system and method for reducing energy consumption by an active suspension system for a vehicle is disclosed. The system and method includes determining whether the vehicle is in park or neutral and determining the speed of the vehicle. The active suspension system is set to a normal operating mode if the speed is greater than a predetermined speed. A throttle angle is determined if the speed is less than a predetermined speed. The active suspension system is set to a normal operating mode if the throttle angle is greater than a predetermined angle and to a power saving mode if the throttle angle is less than a predetermined angle for more than a predetermined amount of time.

### RELATED APPLICATIONS

This application is a continuation-in-part application of U.S. patent application Ser. No. 15/679,895, which is incorporated by reference herein in its entirety.

### TECHNICAL FIELD

The embodiments described herein are related to the suspension systems for vehicles, and more specifically modes for an active or adaptive suspension system.

### BACKGROUND

Vehicles, such as a side-by-side utility vehicle (“S×S”), may include an active or adaptive suspension system for providing a smooth ride to a user. Active suspensions and adaptive suspensions or semi-active suspensions (herein described collectively as an “active suspension system”) are types of suspensions that control the vertical movement of the wheels of the vehicle relative to a chassis or a body of the vehicle with an onboard system. This differs from passive suspensions where the movement is determined entirely by the road surface.

The active suspension system may include dampers to control the vertical movement of the wheels. The dampers are may be electrically actuated hydraulic dampers controlled by servomotors, solenoid-actuated hydraulic dampers, magnetorheological dampers, or any other type of dampers known to those skilled in the art. Sensors continually monitor body movement and vehicle ride level, constantly supplying an electronic control unit (“ECU”) that controls the active suspension system with new data. As the ECU receives and processes data, it operates the dampers mounted beside each wheel. Almost instantly, the dampers generate counter forces to body lean, dive, and squat during driving maneuvers. However, the electronics associated with an active suspension system may provide a significant drain on the vehicle's battery. Therefore, there is established a need to provide a system for managing the active suspension system's power usage.

### APPLICATION SUMMARY

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

According to one aspect, a method for reducing energy consumption by an active suspension system for a vehicle includes the steps of determining whether the vehicle is in park or neutral, and setting the active suspension system to a power saving mode if the vehicle is determined to be in park or neutral.

According to another aspect, a method for reducing energy consumption by an active suspension system for a vehicle includes the steps of determining whether the vehicle is in park or neutral, determining the speed of the vehicle, setting the active suspension system to a normal operating mode if the speed is greater than a predetermined speed, determining a throttle angle of the vehicle if the speed is less than a predetermined speed, setting the active suspension system to a normal operating mode if the throttle angle is greater than a predetermined angle, and setting the active suspension system to a power saving mode if the throttle angle is less than a predetermined angle for more than a predetermined amount of time.

According to yet another aspect, a system for reducing energy consumption by an active suspension system for a vehicle includes a first sensor for determining whether the vehicle is in park or neutral, wherein the active suspension system is set to a power saving mode if the vehicle is determined to be in park or neutral, and wherein the active suspension system is set to a normal operating mode if the vehicle is determined to be in a gear other than park or neutral.

### BRIEF DESCRIPTION OF THE DRAWINGS

FIG. 1 is a schematic view of a vehicle with an active suspension system.

FIG. 2 is a flowchart depicting a method of selecting between a normal operating mode and a power saving mode of operation of the active suspension system of FIG. 1.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

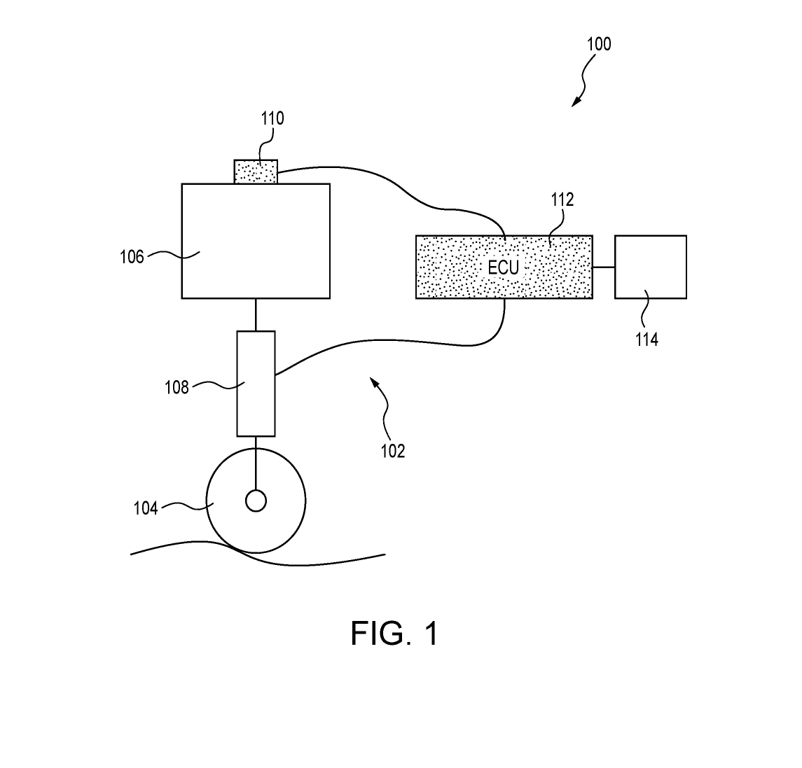

FIG. 1 schematically illustrates an active suspension system 102 for providing a smooth ride to a user of a vehicle 100, such as a side-by-side utility vehicle (“S×S”). Active suspensions and adaptive suspensions or semi-active suspensions (herein described collectively as an “active suspension system”) are types of suspensions that control the vertical movement of the wheels 104 of the vehicle relative to a chassis or a body 106 of the vehicle 100 with an onboard system. This differs from passive suspensions where the movement is determined entirely by the road surface.

The active suspension system 102 may include dampers 108 to control the vertical movement of the wheels 104. The dampers 108 may be electrically actuated hydraulic dampers controlled by servomotors, solenoid-actuated hydraulic dampers, magnetorheological dampers, or any other type of dampers known to those skilled in the art. Sensors 110 continually monitor body 106 movement and vehicle 100 ride level, constantly supplying an electronic control unit (“ECU”) 112 that controls the active suspension system 102 with new data. As the ECU 112 receives and processes data, it operates the dampers 108 mounted beside each wheel 104. Almost instantly, the dampers 108 generates counter forces to body 106 lean, dive, and squat during driving maneuvers.

For a smaller vehicle, such as an S×S, continuous operation of sensors 110 may drain a smaller battery 114 in the vehicle 100. Therefore, there is a need to have two modes for the active suspension system 102, a power saving mode while the vehicle 100 is not in motion, and a normal operating mode when the vehicle 100 is in an operating state. The normal operating mode is a mode in which all sensors 110 continue to operate and report data to the ECU 112, and the ECU 112 in turn controls the active suspension system 102. The power saving mode is a mode in which the sensors 110 of the active suspension system 102 are operated minimally, such that the sensors 110 consume the least amount of power to decrease the load on the battery 114 and charge system of the vehicle 100.

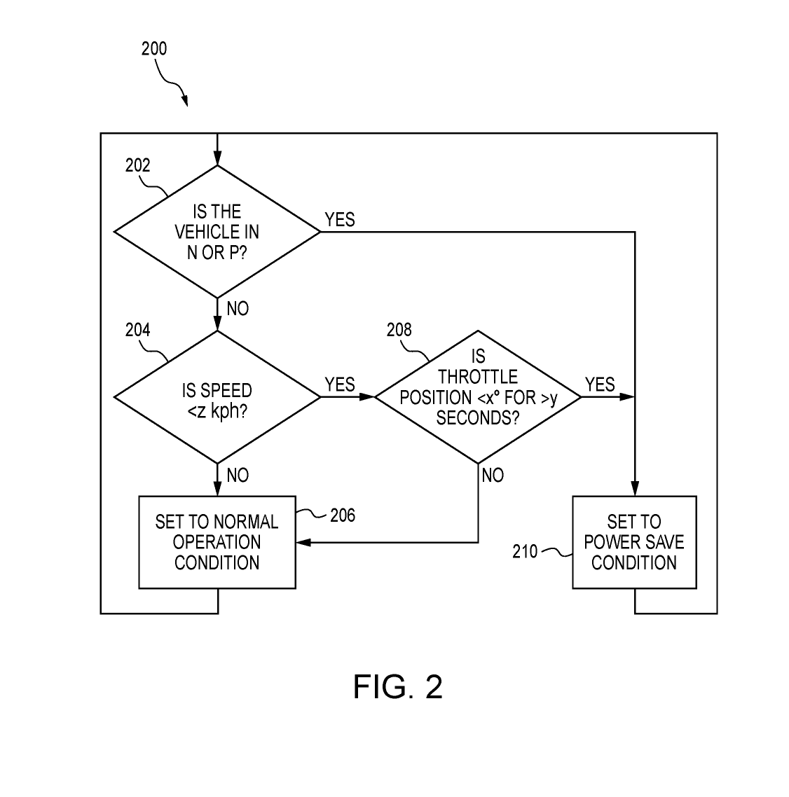

FIG. 2 is a flow chart illustrating operation of the active suspension system 102 and the method 200 of selecting between operating modes. The first step 202 is to determine whether the vehicle 100 is in either park or neutral gear. The vehicle 100 may use a sensor to detect the gear, or any other suitable method of determining the gear in which the vehicle is operating may be used. If the vehicle 100 is determined to be in either park or neutral gear, the method moves to step 210, in which the power saving mode is selected.

If the vehicle 100 is determined to be in a drive gear, the method 200 moves to the step 204 of determining the speed of the vehicle 100. The speed is determined by any suitable method known to one skilled in the art, such as by a speedometer or any other suitable sensor. If the speed is determined to be greater than a predetermined speed of z km/h, such as 5 km/h, or any suitable speed between 0 km/h and 7 km/h, as predetermined based on the vehicle 100, then the method 200 moves to step 206, setting the active suspension system 102 to a normal operating mode.

If the speed is determined to be less than a predetermined speed of z km/h, such as 2 km/h, then the method 200 moves to step 208 to determine a throttle angle of the vehicle 100. The throttle angle, in which an increasing positive value indicates an increase of fuel introduced to the engine (not shown) of the vehicle 100, may be determined by a sensor on the gas pedal or by any other method known to one skilled in the art. If the throttle angle is greater than a predetermined angle of x°, such as 5° in one embodiment, or any appropriate angle between 3° and 7° based on vehicle 100, signifying the user indicating a desire to move, the active suspension system 102 is set to the normal operating mode in step 206. If the throttle angle is less than the predetermined angle x° for more than a predetermined amount of time of y seconds, such as 15 seconds, or any other suitable value between 10-20 seconds as tuned for the vehicle 100, signifying no user activity to move the vehicle 100, then the active suspension system 102 is set to the power saving mode in step 210.

Each time the method 200 enters step 206 to set a normal operating mode or step 210 to set a power saving mode, the method 200 then repeats in an iterative process. The method may be repeat at a cycle of between 20 and 100 hertz.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments, which is set forth in the claims.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

What is claimed is:

1. A method for reducing energy consumption by an active suspension system for a vehicle, comprising the steps of:
determining whether the vehicle is in park or neutral; and
setting the active suspension system to a power saving mode if the vehicle is determined to be in park or neutral.

2. The method of claim 1 further comprising the steps of:
setting the active suspension system to a normal operating mode if the vehicle is determined to be in a gear other than park or neutral.

3. The method of claim 1 further comprising the step of:
determining the speed of the vehicle.

4. The method of claim 3 further comprising the step of:
setting the active suspension system to a normal operating mode if the speed is greater than a predetermined speed.

5. The method of claim 3 further comprising the step of:
setting the active suspension system to a power saving mode if the speed is less than a predetermined speed.

6. The method of claim 3 further comprising the step of:
determining a throttle angle of the vehicle if the speed is less than a predetermined speed.

7. The method of claim 6 further comprising the step of:
setting the active suspension system to a power saving mode if the throttle angle is less than a predetermined angle.

8. The method of claim 6 further comprising the step of:
setting the active suspension system to a power saving mode if the throttle angle is less than a predetermined angle for more than a predetermined amount of time.

9. The method of claim 6 further comprising the step of:
setting the active suspension system to a normal operating mode if the throttle angle is greater than a predetermined angle.

10. A method for reducing energy consumption by an active suspension system for a vehicle, comprising the steps of:
determining whether the vehicle is in park or neutral;
determining the speed of the vehicle;
setting the active suspension system to a normal operating mode if the speed is greater than a predetermined speed;
determining a throttle angle of the vehicle if the speed is less than a predetermined speed;
setting the active suspension system to a normal operating mode if the throttle angle is greater than a predetermined angle; and
setting the active suspension system to a power saving mode if the throttle angle is less than a predetermined angle for more than a predetermined amount of time.

11. The method of claim 10 wherein the method is repeated.

12. The method of claim 11 wherein the method is repeated at rate between 20 and 100 hertz.

13. A system for reducing energy consumption by an active suspension system for a vehicle, comprising:
a first sensor for determining whether the vehicle is in park or neutral;
wherein the active suspension system is set to a power saving mode if the vehicle is determined to be in park or neutral; and
wherein the active suspension system is set to a normal operating mode if the vehicle is determined to be in a gear other than park or neutral.

14. The system of claim 13 further comprising:
a second sensor for determining the speed of the vehicle;
wherein the active suspension system is set to the normal operating mode if the speed is greater than a predetermined speed; and
wherein the active suspension system is set to the power saving mode if the speed is less than a predetermined speed.

15. The system of claim 14 further comprising:
a third sensor for determining a throttle angle of the vehicle if the speed is less than a predetermined speed.

16. The system of claim 15 wherein the active suspension system is set to the power saving mode if the throttle angle is less than a predetermined angle.

17. The system of claim 15 wherein the active suspension system is set to the power saving mode if the throttle angle is less than a predetermined angle for more than a predetermined amount of time.

18. The system of claim 17 wherein the predetermined amount of time is greater than or equal to 15 seconds.

19. The system of claim 15 wherein the active suspension system is set to the normal operating mode if the throttle angle is greater than a predetermined angle.

20. The system of claim 15 wherein the first sensor is a sensor disposed on a shifter for determining a gear selection, the second sensor is a speedometer, and the third sensor is a sensor detecting the movement of a gas pedal.
